(19) United States
(12) Patent Application Publication
(10) Pub. No.: US 2015/0381672 A1
(43) Pub. Date: Dec. 31, 2015

(54) METHOD OF MANAGING AND SHARING FILE IN HOME NETWORK SYSTEM

(71) Applicant: D-Link Corporation, Taipei City (TW)

(72) Inventors: Pai-Hui WANG, Taipei City (TW); Chien-Chao TSENG, Taipei City (TW); Ted Tsei KUO, Taipei City (TW)

(73) Assignee: D-LINK CORPORATION, Taipei City (TW)

(21) Appl. No.: 14/617,161

(22) Filed: Feb. 9, 2015

(30) Foreign Application Priority Data
Jun. 25, 2014 (TW) 103121902

(51) Int. Cl. H04L 29/06; H04L 29/12; H04L 29/08

(52) U.S. Cl. CPC H04L 65/403; H04L 67/1061; H04L 61/1552

(57) ABSTRACT

The present invention is to provide a method of managing and sharing file in a home network system including an information sharing server and a plurality of network devices within a local area network. When one of the network devices enters into the local area network and is connected with the information sharing server, the network device transmits a file updating message to the information sharing server, and the information sharing server stores the content carried in the file updating message to a file sharing information table and then transmits the file sharing information table to each of the network devices within the local area network periodically or according to a request of each of the network devices, to enable each network device to directly connect with other network device according to the file sharing information table, so as to acquire the shared file stored in the other network device.

### FIELD OF THE INVENTION

The present disclosure generally relates to a file sharing method, more particularly to a method of managing and sharing file in home network system.

### BACKGROUND OF THE INVENTION

As the mobile broadband networking technology is developed and the electric industry is rapidly improved, various mobile network devices having networking and multimedia functions come into the market, such as smart phone, a Tablet PC, and an E-book reader, etc. The mobile network device can be carried easily and has various functions of, such as, taking picture, playing music, processing paperwork, receiving and sending email, downloading and playing streaming media, etc., so the user just needs to carry one mobile network device which can serve as different kinds of electronic devices, the usage convenience for the user can be improved efficiently, and the user's demands for work or entertainments can be satisfied. That is the reason that the mobile network device almost becomes one of daily commodities for people.

Various network applications have gone deeply into people's daily life and mobile network devices become more and more popular, so the user can use the network device to record the colorful life, and some users additionally buy various storage devices to store multimedia files, such as pictures or videos, which record daily life or outdoor travels. The storage devices are usually placed at home. When the user's multimedia files become more and more, how to manage the multimedia files and share multimedia files between different users becomes a topic on which people pay more attention. Traditional and common methods of managing and sharing file can be classified into two types. In the first method, the user must create a data folder in a personal computer, and set the access authority of the data folder as a sharing status, whereby the data folder is formed as a shared data folder and other network device (such as a smart phone, a digital camera, a tablet PC, etc.,) located at the same home network as the personal computer can access the content of the shared data folder. In addition, the user can store the multimedia file to be shared in the shared data folder, and the multimedia file can be accessed by other network device via the personal computer.

It is assumed that the personal computer has a network interface using a network address IPa and activating a port Pa, and the network device has a network interface using a network address IPb and activating a port Pb. A process of the network device acquiring the multimedia file being shared in the personal computer is described in following paragraph. First, the network device transmits a broadcast packet in the home network, and the broadcast packet contains a multimedia file sharing inquiry message. After the personal computer receives the broadcast packet transmitted from the network device, because the shared data folder is created in the personal computer, the personal computer generates a reply message which contains the network address IPa and the port Pa of the personal computer, and then transmits the reply message to the network address IPb and the port Pb of the network device. After the network device receives the reply message transmitted from the personal computer, the network device directly transmits a query request message to the personal computer (to the network address IPa and the port Pa). After the personal computer receives the query request message, the personal computer lists the multimedia files shared in the shared data folder in a sharing reply message and transmits the sharing reply message to the network device (to the network address IPb and the port Pb). Therefore, the network device can utilize the sharing information included in the sharing reply message to access the multimedia file to be shared in the personal computer.

In the second method, a network attached storage (abbreviated as “NAS”) is disposed in the home network, and the user uploads the multimedia file to be shared to the network attached storage. Other network device can directly acquire the shared multimedia file from the network attached storage. It is assumed that network attached storage has a network interface using a network address IPc and activating a port Pc, and the network device has a network interface using a network address IPd and activating a port Pd. A process of the network device acquiring the multimedia file being shared in the personal computer is described in following paragraph. First, the user stores the multimedia file to be shared to the network attached storage, and the network device then can transmit a query request message to the network address IPc and the port Pc of the network attached storage. After the network attached storage receives the query request message, the network attached storage replies a sharing reply message to the network device. The sharing reply message includes the sharing information related to the multimedia file stored in the network attached storage. Finally, after the network device receives the sharing reply message, the network device can utilize the sharing information to access the multimedia file stored in the network attached storage.

To sum up, in most of the traditional and common sharing methods, the user directly copies the multimedia file stored in a personally owned device to a shared data folder of the personal computer, and then shares this multimedia file to other user; or the user directly uploads the multimedia file to the network attached storage and then other user can utilize personally owned network device to access the multimedia file, so as to achieve the purpose of sharing file. However, as the multimedia files become more and more, the user is bound to spend a lot of time and resource to search a specific file from numerous multimedia files. In addition, when the multimedia file is not copied to the personal computer or uploaded to the network attached storage yet, the other user cannot access the multimedia file. It causes the inconvenience in sharing, and the user also has to spend time in storing the multimedia file to the personal computer or the network attached storage. Therefore, how to design a new method of managing and sharing file to provide user a nice usage experience becomes an important subject for manufacturers.

### SUMMARY OF THE INVENTION

In order to solve the problems existing in the traditional method of managing and sharing file, the inventor develops and designs a method of managing and sharing the file in the home network system of the present disclosure based on long-term researches and experiments. According to the present disclosure, the files distributed in multiple devices can be integrated, so members in the home network can directly connect to the device which stores the file to be shared, whereby a quick sharing effect can be achieved and a nice sharing experience can be provided to the user.

An objective of the present disclosure is to provide a method of managing and sharing file in home network system. The method is adapted for a home network system which is within a local area network and includes an information sharing server and a plurality of network devices. The information sharing server is provided with a file sharing information table which at least includes a filename column, an IP address column and a tag column. In the method, when one of the plurality of network devices enters into the local area network and is connected with the information sharing server, the network device transmits a file updating message to the information sharing server, and the information sharing server stores the name of the shared file, the IP address of the network device and the updating time of the shared file which are carried in the file updating message, to the file sharing information table, respectively. The information sharing server transmits the file sharing information table to each of the plurality of network devices within the local area network periodically or according to a request of each of the plurality of network devices, to enable each network device to directly connect with other network device according to the file sharing information table, so as to acquire the shared file stored in the other network device. Therefore, the user can quickly acquire the shared file, and the operation burden of the information sharing server can also be reduced.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a network structural view of a home network system of the present disclosure;

FIG. 2 is a schematic view of a file sharing information table of the present disclosure;

FIG. 3 is a timing diagram of updating the file sharing information at the home network system; and

FIG. 4 is a timing diagram of a network device of the home network system acquiring a shared file.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

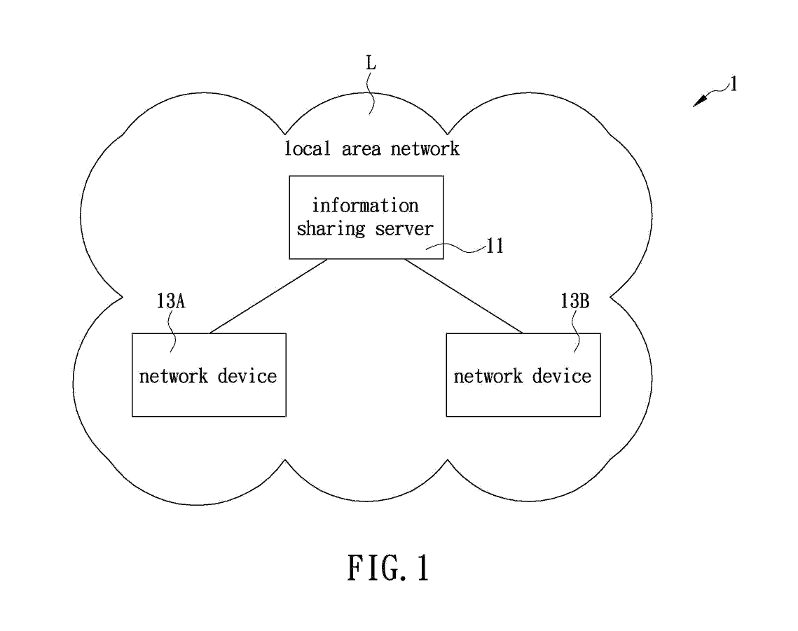

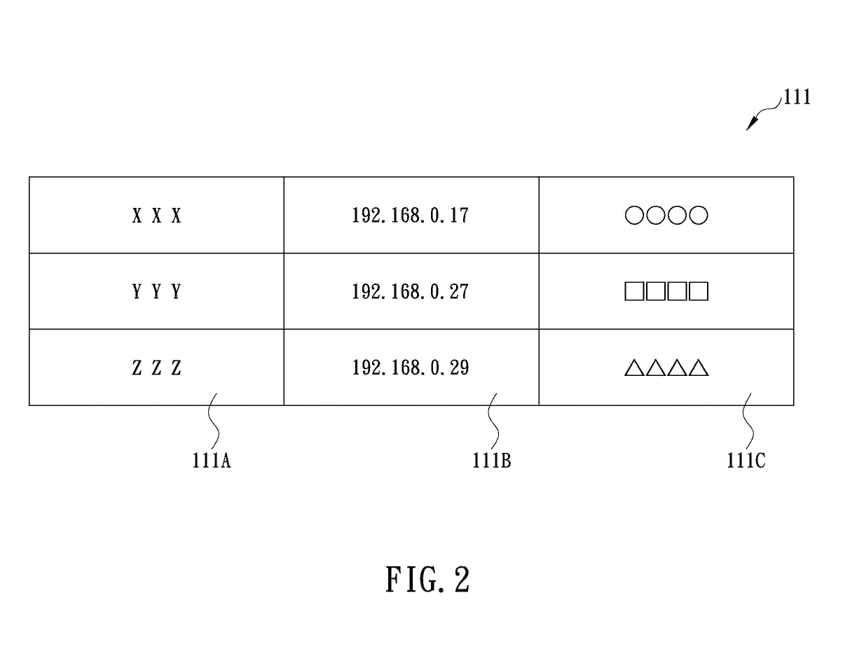

The present disclosure illustrates a method of managing and sharing file in home network system. The method is adapted for a home network system 1 within a local area network L which is also called as home network. Please refer to FIG. 1 and FIG. 2. In an embodiment, the home network system 1 includes an information sharing server 11 and a plurality of network devices 13A and 13B which are electronic devices having networking capability, such as a smart phone, a tablet computer, an electronic book reader, a notebook PC, a desktop computer and a network attached storage, etc. Wireless connections or wired connections are built among the information sharing server 11, and each of the network devices 13A and 13B. The information sharing server 11 is provided with a file sharing information table 111 including a plurality of columns which at least include a filename column 111A, an IP address column 111B and a tag column 111C. The filename column 111A is configured for storing a filename containing a storage path which indicates a position where the file is stored in one of the network devices 13A and 13B. In the FIG. 2, the storage path is omitted. The IP address column 111B is configured for storing IP addresses of the network devices 13A and 13B. The tag column 111C is configured for indicating an updating time or other relative information of the file, such as file size, file format, etc.

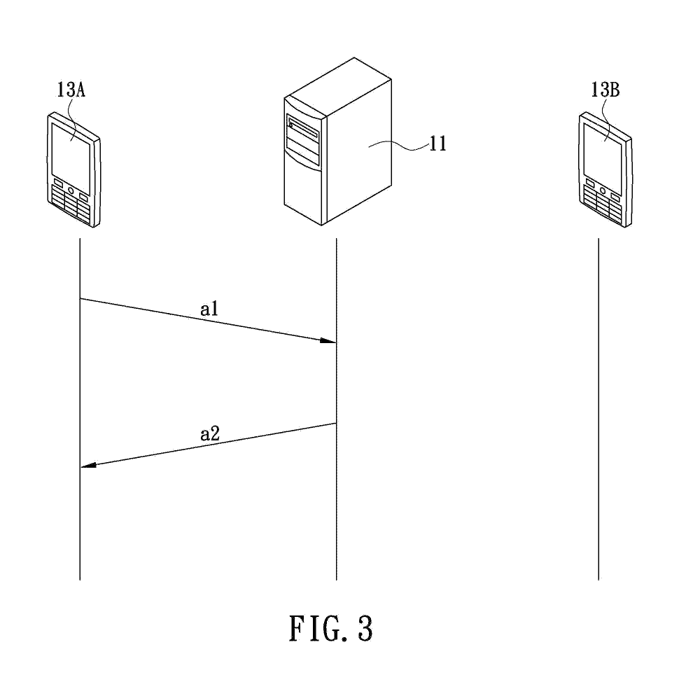

Please refer to FIG. 1 through FIG. 3 which illustrates a flow of updating the file sharing information in the home network system 1. When the network device 13A enters into the local area network L, a connection is established between the network device 13A and the information sharing server 11 automatically or by user's setting operation. The manner of establishing the wireless connection between the network device 13A and the information sharing server 11 is a traditional technology, so detailed description is omitted. After the network device 13A and the information sharing server 11 are connected with each other, the network device 13A transmits a file updating message to the information sharing server 11, such as the flow a1 shown in FIG. 3. The file updating message includes the name of the shared file to be shared by the network device 13A (this name of the shared file further includes the storage path indicating the position where the shared file is stored in the network device 13A), the IP address of the network device 13A, an updating time of the shared file or other relative information. After the information sharing server 11 receives the file updating message, the information sharing server 11 stores the contents carried in the file updating message to the filename column 111A, the IP address column 111B and the tag column 111C, respectively. The information sharing server 11 then transmits a reply updating message to the network device 13A, such as the flow a2 shown in FIG. 3, so that the network device 13A can be informed that the information sharing server 11 completes the process of updating the file sharing information. It particularly mentions that the IP address column 111B can be changed to record other format different from the format of IP address, so long as the record content of the IP address column 111B of the present disclosure enables the network devices 13A and 13B to acquire information about connection with each other.

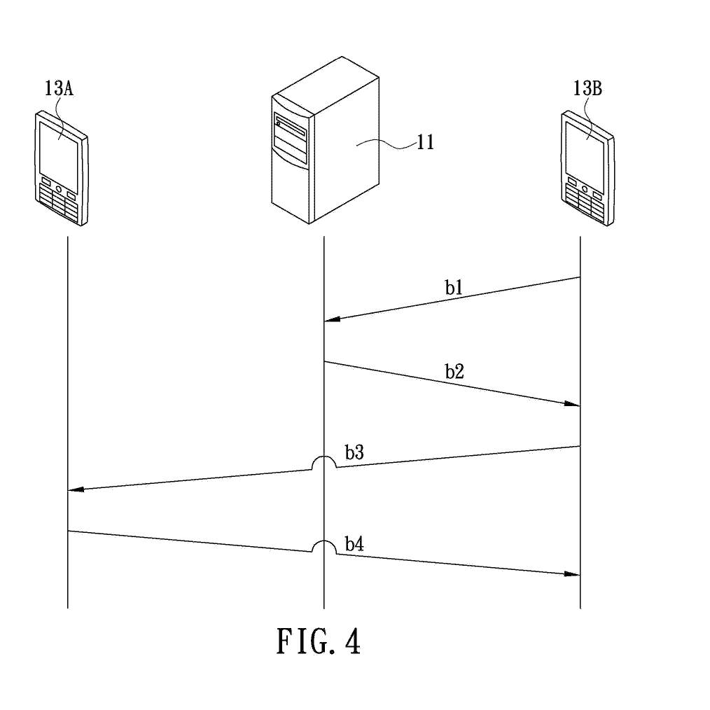

Moreover, the flows about how each of the network devices 13A and 13B acquires the shared file in the home network system 1, is described in following paragraph. Please refer to FIG. 1, FIG. 2 and FIG. 4. When the user who carries the network device 13B wants to acquire a file, the user can transmit a file request message to the information sharing server 11 via the network device 13B, such as the flow b1 shown in FIG. 4, and after the information sharing server 11 receives the file request message, the information sharing server 11 returns the file sharing information table 111 to the network device 13B, such as the flow b2 shown in FIG. 4. After the network device 13B receives the file sharing information table 111, the network device 13B parses the content of the file sharing information table 111 and shows the content on a display screen for the user's review. After the user operates the network device 13B (such as an input unit of the network device 13B including a touch control screen or button, etc.) to select a shared file to be downloaded, the network device 13B then acquires an IP address corresponding to the shared file. If the shared file is stored in the network device 13A, the IP address is an IP address of the network device 13A. The network device 13B is then connected with the network device 13A by the IP address, and transmits a file acquiring request message to the network device 13A, such as the flow b3 shown in FIG. 4. The file acquiring request message at least includes the name of the shared file. Upon receipt of the file acquiring request message, the network device 13A determines whether the shared file corresponding to the name in the file acquiring request message exists or not. If this shared file exists, the network device 13A transmits the shared file to the network device 13B, such as the flow b4 shown in FIG. 4. If this shared file does not exist, the network device 13A transmits a file not found message to the network device 13B.

Therefore, as shown in FIG. 1 and FIG. 2, according to the method of the present disclosure, when the first user (such as son) is back home and wants to share various files, such as pictures, videos or documents, stored in his network device 13A, he can just transmits a file updating message to the information sharing server 11 without uploading the files which is to be shared, to the information sharing server 11. Therefore, it is not necessary to configure large amount of storage units in the information sharing server 11. Moreover, when a second user (such as mother) wants to acquire the file which is shared already, she can acquire the file sharing information table 111 from the information sharing server 11 via her network device 13B, and the network device 13B then can be directly connected with the network device 13A to acquire the shared file stored in the network device 13A, whereby the bandwidth load of the information sharing server 11 can be efficiently reduced.

Please refer to FIG. 1 and FIG. 2. It particularly mentions that in the above-mentioned embodiment the information sharing server 11 transmits the file sharing information table 111 to the network device 13B upon receipt of the file request message transmitted from the network device 13B; However, it should be noted that in other embodiments of the present disclosure the information sharing server 11 can periodically (i.e. in a predetermined time) transmits the file sharing information table 111 to network devices 13A and 13B currently located in the local area network L; or the information sharing server 11 can actively transmit the file sharing information table 111 to the network devices 13A and 13B after the information sharing server 11 receives the file updating message from one of network devices 13A and 13B and completes the update.

Moreover, please refer to FIG. 1 and FIG. 2. After receiving the file sharing information table 111, apart from downloading the shared file according to the file sharing information table 111, each of the network device 13A and 13B can further determine whether data (such as the name or updating time) of the file to be shared match with the data recorded in the file sharing information table 111. If the data of the file to be shared do not match with the data recorded in the file sharing information table 111, each of the network devices 13A and 13B transmits other file updating message to the information sharing server 11, whereby the information sharing server 11 can increase, delete or amend the data stored in the corresponding column in the file sharing information table 111 according to the other file updating message.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of managing and sharing file in a home network system, wherein the method is applied to the home network system within a local area network, the home network system comprises an information sharing server and a plurality of network devices, the information sharing server is provided with a file sharing information table, and the method includes following steps executed by the home network system:
transmitting a file updating message to the information sharing server by anyone of the network devices when the network device enters into the local area network and is connected with the information sharing server;
storing content carried in the file updating message to the file sharing information table by the information sharing server;
transmitting the file sharing information table to each of the network devices within the local area network by the information sharing server periodically or according to a request of each of the network devices within the local area network; and
enabling each of the network devices to directly connect with the other network device to acquire a shared file stored in the other network device according to the file sharing information table.

2. The method as defined in the claim 1, wherein the file sharing information table comprises a plurality of columns at least including a filename column, an IP address column and a tag column, the filename column is configured for storing a filename of a file to be shared, the IP address column is configured for storing an IP address of the network device where the file is stored, and the tag column is configured for indicating an updating time or other relative information of the file.

3. The method as defined in the claim 2, wherein the content carried in the file updating message at least comprises a name of a shared file, an IP address of the network device and an updating time of the shared file.

4. The method as defined in claim 3, wherein the step of transmitting the file sharing information table to each of the network devices within the local area network by the information sharing server according to the request of each of the network devices within the local area network, so as to enable each of the network devices to directly connect with the other network device, comprises:
transmitting a file request message to the information sharing server by one of the network devices;
transmitting the file sharing information table to the network device by the information sharing server upon receipt of the file request message;
reading the content of the file sharing information table by the network device upon receipt of the file sharing information table, so as to search the shared file to be downloaded and the IP address corresponding thereto from the file sharing information table;
transmitting a file acquiring request message to the other network device by the network device according to the corresponding IP address; and
determining by the other network device upon receipt of the file acquiring request message whether or not the shared file requested in the file acquiring request message exists in the other network device, and if the shared file exists, transmitting the shared file to the network device by the other network device.

5. The method as defined in the claim 3, wherein after receiving the file sharing information table, each of the network devices further executes following steps:
determining whether the name and the updating time of the shared file match with the data stored in the corresponding columns of the file sharing information table;
transmitting other file updating message to the information sharing server if the name and the updating time of the shared file do not match with the data stored in the corresponding columns of the file sharing information table, so as to enable the information sharing server to increase, delete or amend the data stored in the corresponding column of the file sharing information table.

6. The method as defined in the claim 4, wherein after receiving the file sharing information table, each of the network devices further executes following steps:
determining whether the name and the updating time of the shared file match with the data stored in the corresponding columns of the file sharing information table;
transmitting other file updating message to the information sharing server if the name and the updating time of the shared file do not match with the data stored in the corresponding columns of the file sharing information table, so as to enable the information sharing server to increase, delete or amend the data stored in the corresponding column of the file sharing information table.

7. The method as defined in the claim 5, wherein a wireless or wired connection is established between the information sharing server and each of the network devices, or between the network devices.

8. The method as defined in the claim 6, wherein a wireless or wired connection is established between the information sharing server and each of the network devices, or between the network devices.
